(19) United States
(12) Patent Application Publication
(10) Pub. No.: US 2012/0033448 A1
(43) Pub. Date: Feb. 9, 2012

(54) NIGHT LIGHT

(75) Inventors: James Anderson, Scottsdale, AZ (US); JoAnn Anderson, Scottsdale, AZ (US); Eileen Toomey, Norwood, NJ (US)

(73) Assignee: AMERICAN TACK & HARDWARE CO., INC., Saddle River, NJ (US)

(21) Appl. No.: 13/104,947

(22) Filed: May 10, 2011

Related U.S. Application Data
(60) Provisional application No. 61/333,117, filed on May 10, 2010.

(51) Int. Cl. F21V 23/06

(52) U.S. Cl. 362/641

(57) ABSTRACT

A night light having a visual and sound generating device activated by a controller that allows the visual and/or sound generating device to provide a visual display and an audible message that may be interpreted as the completion of a search of the area where the night light is positioned without the detection of abnormal activity.

### CROSS-REFERENCE TO RELATED APPLICATIONS

This application claims priority to provisional application no. 61333117 filed May 10, 2010.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### REFERENCE TO A MICROFICHE APPENDIX

Not Applicable

### BACKGROUND OF THE INVENTION

1) Field of the Invention

This invention is directed to night light having visual and/or sound generating means for providing a message that an illusionary search has been successfully completed for abnormal activity in order to reassure young children who are fearful of untoward events that may happen at or after their bedtime.

2) Description of Related Art

Night lights are well known and have been used to provide illumination for avoiding accidents due to night time movements in low light environments. These night lights are often provided in rooms where children sleep so that a low level of illumination is provided in order to reassure children who often fear darkness. No night lights are known that provide a means for generating a signal continuously or in response to an activatable control means that is intended to provide a report that is intended to provide a basis for allaying a child's fears.

### SUMMARY OF THE INVENTION

The invention is directed to a night light having visual and sound generating means that is automatically or manually activated by a control means where said visual and/or sound generating means is adapted to provide a visual display and an audible message that may be interpreted as a search of the area where the night light is positioned has been completed and that no abnormal activity has been detected.

It is an object of the invention to provide a night light having sound generating means for the purpose of providing a audible report that may be interpreted as a search for abnormal activity is or has been made and that no abnormal activity has been detected.

It is an object of the invention to provide a night light having visual generating means for the purpose of providing a visual indication that may be interpreted as a search for abnormal activity is or has been made and that no abnormal activity has been detected.

It is also an object of this invention to provide a means for allaying a child's fears about imaginary events or creatures that the child fears are in or around the area where a child normally sleeps.

These and other objects of the invention will become apparent from the appended detailed description.

### BRIEF DESCRIPTION OF THE SEVERAL VIEWS OF THE DRAWINGS

FIG. 1 is a perspective view if a night light having sound generating means according to the invention.

FIG. 2 is a front view of a night light having sound generating means according to the invention.

FIG. 3 is a left side view of a night light having sound generating means according to the invention.

FIG. 4 is a top view of a night light having sound generating means according to the invention.

FIG. 5 is a back view of a night light having sound generating means according to the invention.

FIG. 6 is a right side view of a night light having sound generating means according to the invention.

FIG. 7 is a bottom view of a night light having sound generating means according to the invention.

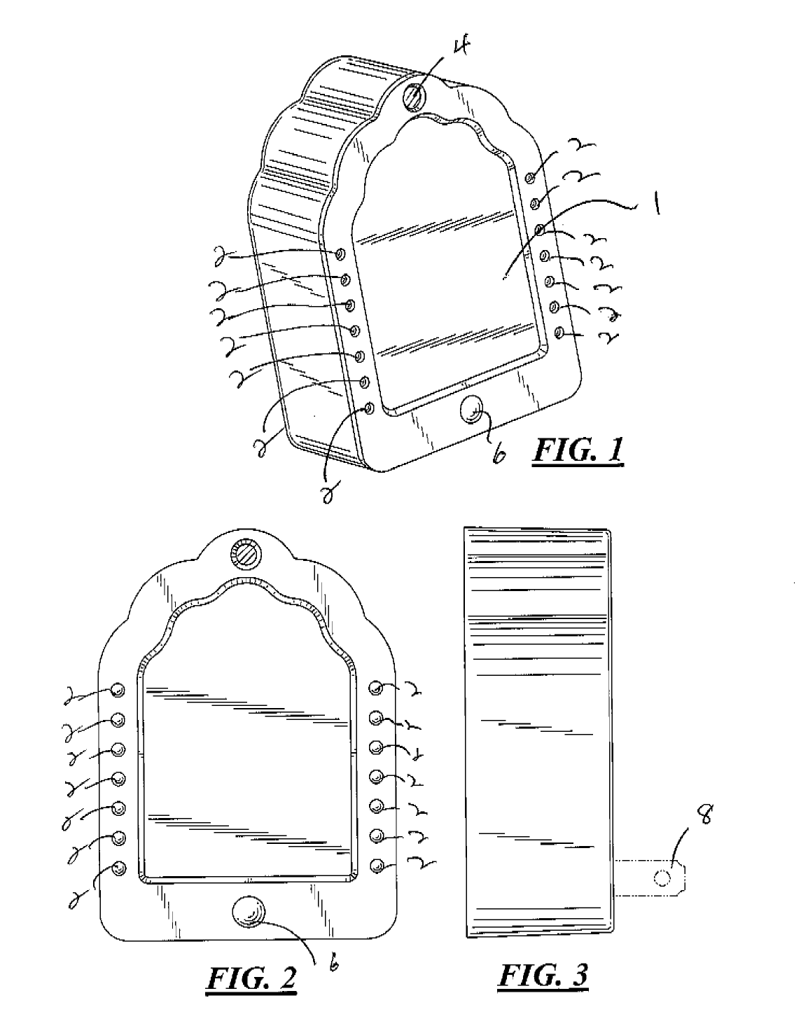

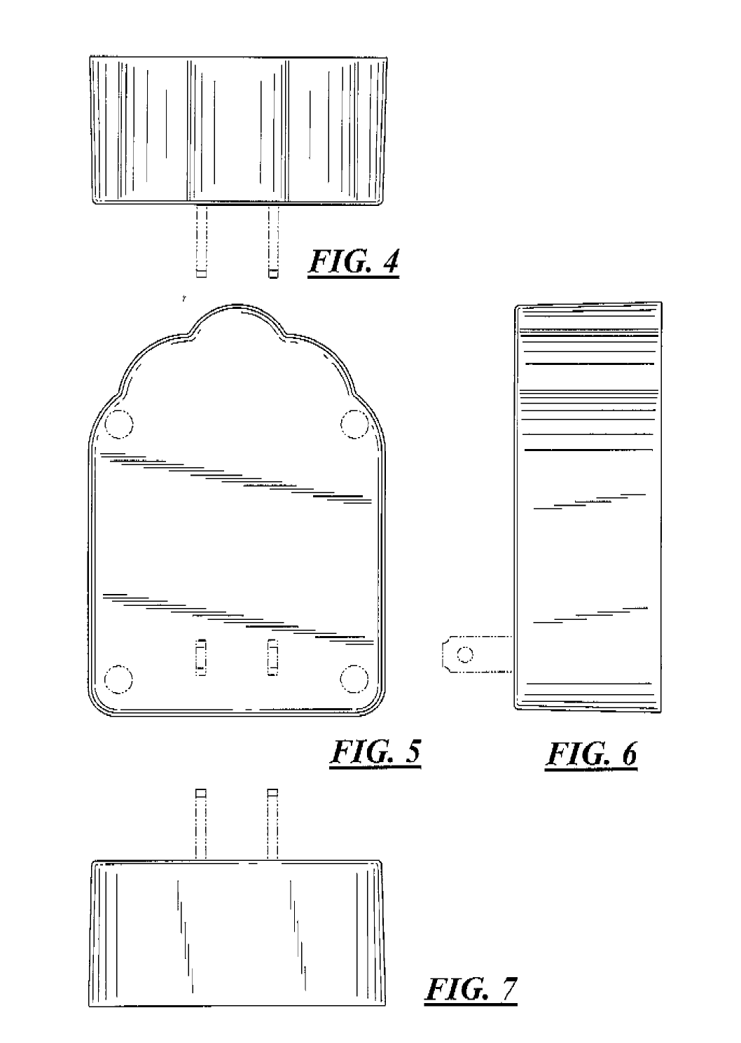

### DETAILED DESCRIPTION OF THE INVENTION

It is well known that young children are often fearful of the dark and that these fears tend to arise at bedtime. These fears may be manifested by descriptions of abnormal or paranormal things and creatures such as monsters, dragons, unconventionally clothed persons with exaggerated features etc.

The present invention provides a means for parents to allay a child's fears that may arise at bedtime by providing in the child's sleeping area, a night light that has an electronic circuit that includes memory and sound generating means that are provided in combination with a night light on which are mounted controls for activating pre-programmed sounds that are explainable to a child as a search for abnormal or paranormal things and creatures with a concluding visual or audible “all clear” message that is intended to assure the child that the device has searched for anything that in the child's imagination could be a threat to the child and that the search has been negative.

The intent of the operation of the night light of the invention is to impart a sense of comfort and security to children that reinforces parental assurances that there is nothing to fear about the area in which the child sleeps.

As best seen in FIG. 1, the night light of the invention has a light emitting area 1 that house light emitting means which may be an incandescent or fluorescent bulb, one or more light emitting diodes (LED), or an electroluminescent film. A preferred embodiment may comprise a series of LED 2 around the perimeter of the night light. The LED 2 may be programmed to flash in a predetermined sequence that may be explained as a continuous scan for abnormal activity. In the alternative, a control button 6 may be provided that will activate the LED 2 in a predetermined flashing sequence that may be explained as the conclusion of the search for abnormal activity with negative results by a special visual effect such as the simultaneous flashing of all of the LED 2. The LED 2 may be arranged so that there are red, yellow and green LEDs that may be programmed to display a green LED all clear type of signal at the end of a sequence of lights flashes. It is also contemplated that a sound program may be stored in an electronic memory mounted inside of the night light that either provides an audible search report with or without the LED display.

In the alternative, a second button, similar to control button 6 may be provided that will control the activation of a test of the circuit that controls the LED 2 by causing all of the LED to flash simultaneously with or with an audible sound to verify that the device is operating correctly.

It is contemplated that the night light of the invention may be provided with a pre-programmed or programmable electronic audible message means such as that which is used for telephone answering machines that may deliver an audible report of a negative search for abnormal activity with or without a visual display of a negative search for abnormal activity.

Other embodiments of the invention may be made which are all included in the scope of the present invention.

1. A night light having visual and/or sound generating means activated by a control means where said visual and/or sound generating means is adapted to provide a visual display and/or an audible message that reports a search of the immediate area where the night light is positioned has been completed and that no abnormal activity has been detected.

2. A night light according to claim 1, wherein a sound generating means audibly reports that a search for abnormal activity is being made or has been made and that no abnormal activity has been detected.

3. A night light according to claim 1, wherein a visual indication reports that a search for abnormal activity is being made or has been made and that no abnormal activity has been detected.

4. A night light according to claim 1, wherein a sound generating means provides an audible report for allaying a child's fears about imaginary events or creatures that the child fears are in or around the area where a child normally sleeps.

5. A night light according to claim 1, wherein a visual indication provides a report for allaying a child's fears about imaginary events or creatures that the child fears are in or around the area where a child normally sleeps.
